(19) United States
(12) Patent Application Publication
(10) Pub. No.: US 2014/0330694 A1
(43) Pub. Date: Nov. 6, 2014

(54) METHOD AND SYSTEM FOR PREPARATION OF A FINANCIAL TRANSACTION

(71) Applicant: THE ROYAL BANK OF SCOTLAND GROUP PLC, Edinburgh (GB)

(72) Inventors: Nicholas Barker, London (GB); Craig Goulding, London (GB)

(73) Assignee: The Royal Bank of Scotland Group PLC, Edinburgh (GB)

(21) Appl. No.: 13/886,433

(22) Filed: May 3, 2013

(51) Int. Cl. G06Q 40/00

(52) U.S. Cl. CPC G06Q 40/04
USPC 705/37

(57) ABSTRACT

Methods and a system for preparing a financial transaction are described. Input data for a financial information query is received. A query is performed and data for a number of information panels is returned. The data relates to trading information for at least one tradable object associated with the input data. A user may select one or more information panels to generate a trade prompt, which is communicable to a user of a second computing device. Access to the trade prompt allows the user of the second computing device to instruct a trade of one or more tradable objects from the second computing device.

### TECHNICAL FIELD

The present disclosure relates to at least one or more of apparatus, systems and methods for preparing a financial transaction.

### BACKGROUND

Certain financial organizations allow entities to trade tradable objects. The one or more tradable objects may comprise any tradable item, including, amongst others commodities, assets, shares, bonds, derivatives and synthetic objects. For example, the financial organization may be a broker who offers to buy and/or sell one or more tradable objects on behalf of a third party. This broker may receive a telephone call from the third party instructing them to buy and/or sell one or more tradable objects, i.e. to make a trade. The broker then accesses a trading infrastructure comprising an electronic exchange to complete the trade. Alternatively, trading may occur over-the-counter or off-exchange, e.g. directly between two parties without any supervision of an exchange. A financial institution may be a trading party or a facilitator of such a trade.

Financial trading and sales platforms have often been developed based on original person-to-person trading, e.g. by telephone. This has resulted in an onerous process both for the financial organization and their customers. Many modern financial transactions are also heavily regulated. Known systems are difficult to audit to demonstrate compliance with these regulations.

### SUMMARY OF THE DISCLOSURE

In accordance with an example, there is provided a method of preparing a financial transaction comprising: receiving, via a user interface of a first computing device, input data for a financial information query; displaying, on the user interface of the first computing device, one or more information panels resulting from the execution of the financial information query, said information panels comprising financial information relating to at least one tradable object associated with the input data; selecting, via the user interface of the first computing device, one or more information panels to generate a trade prompt associated with the at least one tradable object; and sending a financial transaction message corresponding to the trade prompt to a user of a second computing device, said message providing a means by which the user of the second computing device can instruct, from the second computing device, a trade of one or more tradable objects according to the trade prompt.

In accordance with an example, there is provided a system for preparing a financial transaction comprising: a first computing device comprising a first user interface; a second computing device communicatively coupled to the first computing device and comprising a second user interface; a financial information server at least communicatively coupled to the first computing device, wherein the first user interface comprises a first interface component for receiving input data for a financial information query, wherein the financial information server comprises a first interface to receive said input data from the first computing device and a query engine to execute the financial information query based on the input data, wherein the first user interface comprises a second interface component for displaying data output by the query engine of the financial information server, the second interface component comprising one or more sub-components to enable a user of the first computing device to select one or more items of said data output by the query engine to generate a trade prompt, wherein the second computing device is arranged to receive a financial transaction message from the first computing device and, based on the financial transaction message, to display the trade prompt on the second user interface, the second user interface comprising an interface component to instruct a trade associated with the trade prompt.

In accordance with an example, there is provided a method of preparing a financial transaction comprising: receiving input data for a financial information query; providing data resulting from the execution of the financial information query for one or more information panels, said data comprising financial information relating to at least one tradable object associated with the input data; receiving a selection of one or more of said information panels; and generating a trade prompt associated with the at least one tradable object based on the selection, the trade prompt being communicable to a user of a second computing device and providing a means by which the user of the second computing device can instruct, from the second computing device, a trade of one or more tradable objects.

Further features and advantages of the disclosure will become apparent from the following description of exemplary embodiments of the disclosure, given by way of example only, which is made with reference to the accompanying drawings.

### BRIEF DESCRIPTION OF THE DRAWINGS

FIG. 1 is a schematic diagram showing an arrangement of computing devices according to an example;

FIG. 2 is a flow diagram showing a method of generating a financial transaction according to an example;

FIG. 3A is a sequence diagram showing a sequence of events for generating a financial transaction according to a first example;

FIG. 3B is a sequence diagram showing a sequence of events for generating a financial transaction according to a second example;

FIG. 4A is a schematic diagram showing a user interface for generating a financial transaction according to a first time point in an example;

FIG. 4B is a schematic diagram showing a user interface for generating a financial transaction according to a second time point in an example;

FIG. 4C is a schematic diagram showing a user interface for generating a financial transaction according to a third time point in an example;

FIG. 4D is a schematic diagram showing a user interface for generating a financial transaction according to a fourth time point in an example;

FIG. 4E is a schematic diagram showing a user interface for generating a financial transaction according to a fifth time point in an example;

FIG. 4F is a schematic diagram showing a user interface for generating a financial transaction according to a sixth time point in an example;

FIG. 5A is a schematic diagram showing user interface components associated with a first method of delivering a financial transaction message according an example;

FIG. 5B is a schematic diagram showing a trade prompt displayed following activation of the financial transaction message shown in FIG. 5A;

FIG. 6 is a schematic diagram showing user interface components associated with a second method of delivering a financial transaction message according an example;

FIG. 7A is a schematic diagram showing a user interface for viewing data associated with a user account according to an example;

FIG. 7B is a schematic diagram showing how the user interface of FIG. 7A is updated following the execution of a trade according to an example;

FIG. 8A is a schematic diagram showing, at a first time point, one or more user interface components for use in inputting a financial information query according to an example;

FIG. 8B is a schematic diagram showing, at a second time point, one or more user interface components for use in inputting a financial information query according to an example;

FIG. 8C is a schematic diagram showing one or more user interface components for use in generating a financial transaction according to a first example;

FIG. 9A is a schematic diagram showing, at a first time point, one or more user interface components in for use in generating a financial transaction according to a second example;

FIG. 9B is a schematic diagram showing, at a second time point, one or more user interface components in for use in generating a financial transaction according to a second example; and

FIG. 10 is a schematic diagram showing example components of a computing device.

### DETAILED DESCRIPTION

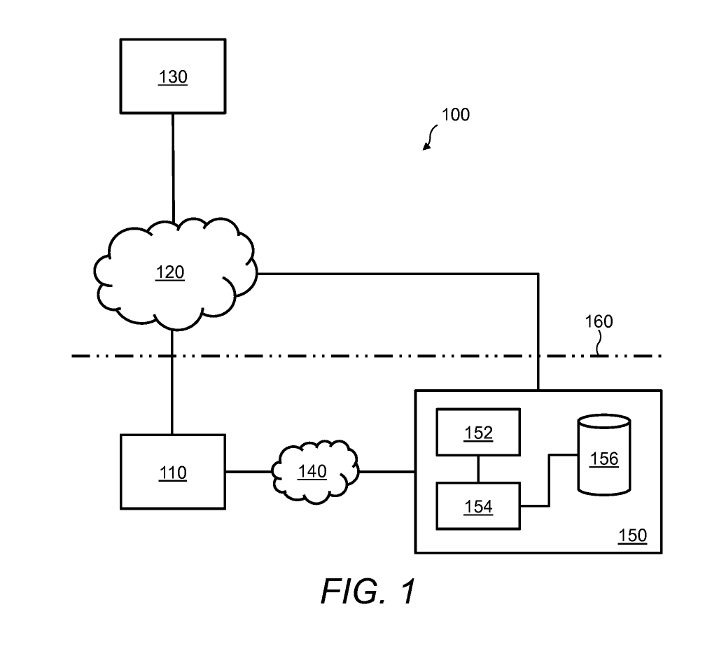

FIG. 1 is a schematic diagram of an exemplary system 100 for conducting a financial transaction. The system comprises a first computing device 110 communicatively coupled to a first computer network 120. The first computer network 120 may comprise one or more: public and/or private networks; wired and/or wireless networks; and local, metropolitan and/or wide-area networks. The first computer network 120 may comprise the Internet, i.e. a set of interconnected networks utilizing the Transmission Control Protocol (TCP) and Internet Protocol (IP). The first computing device 110 is communicatively coupled to a second computing device 130 via the first computer network 120. This coupling may be unsecure, e.g. there may be no single entity that controls the devices coupled to the first computer network 120. The first computing device and/or second computing device may comprise any of desktop computers, laptop computers, tablets, embedded devices, smartphones, cellular phones, thin clients etc. Each computing device may comprise one or more processors, working memory and a display so as to render a user interface. The user interface may be locally or remotely generated.

FIG. 1 also shows an exemplary financial information server 150. In the example of FIG. 1 the financial information server 150 is communicatively coupled to the first computing device 110 via a second computer network 140. This coupling may be secure, e.g. a single entity may control the devices coupled to the second computer network 140 and/or a firewall 160 may be provided to control traffic from the first computer network 120 but not provided for communications via the second computer network 140. In one example, the second network 140 may be a common set of one or more local area networks or comprise one or more virtual private networks operating over one or more public networks. The financial information server 150 comprises a first interface 152 to receive input data from the first computing device 110 over the second computer network 140. In other examples, the first interface 152 may be arranged to receive data sent via the first computer network 120. The financial information server 150 also comprises a query engine 154 to execute a financial information query based on the input data received via the first interface 152. The query engine 154 is arranged to execute a search or query with regard to one or more databases 156. The one or more databases 156 are arranged to store a variety of information, including but not limited to, one or more of: prices or financial metrics, whether “live” or historical; charts; reports; documents; communications including electronic communications and messaging; sales data; trade data; account data; and company data. The one or more databases 156 may also comprise one or more distributed information systems, for example may be implemented using application programming interfaces (APIs) and/or web services.

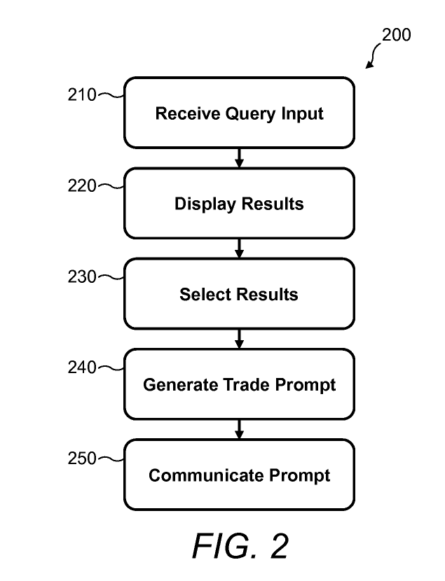

FIG. 2 shows an exemplary method 200 of preparing a financial transaction according to an example. The example will be described with reference to the system 100 of FIG. 1; however other systems may be used to implement the method as required.

At block 210, input data for performing a financial information query is received. For example, this may be received at a user interface of the first computing device 110 following entry by a user. The query is then performed based on the input data. The query may be performed remotely, for example by the financial information server 150 of FIG. 1.

At block 220, results generated from performing the query are displayed. For example, the results may be displayed on the user interface of the first computing device 110. The results may be displayed in a plurality of information panels on the user interface. The information panels may comprise at least one trade ticket associated with the input data and ancillary data associated with the input data. In this example a trade ticket may comprise financial data for a particular tradable object such as live price information. Ancillary data may comprise associated reports, documents, communications and/or other data. The information panels may comprise one or more views of one or more independent software applications that are being processed either locally or remotely. One or more information panels may provide output to the user. One or more information panels may also allow input from a user, for example comprising one or more user interface input components. With regard to a trade ticket this may allow a user to enter information such as one or more of a proposed trade volume, a trade price, thresholds for trading etc. Similar inputs may be received for a chart to change scales, axes and/or other chart data.

At block 230, one or more of the results returned in block 220 are selected. The results may be selected by a user, for example using the user interface of the first computing device 110. The results may be selected by selecting one or more information panels containing different sets of results. The selection may be performed using a user input device such as a mouse, touch screen and/or gesture-based interface.

At block 240, the selected results are used to generate a trade prompt. The trade prompt comprises at least a collection of information that defines a trade of tradable objects. For example, a trade prompt may relate to one or more tradable objects set out in a trade ticket in the results and set out an offer to buy and/or sell a particular set of one or more quantities of the one or more tradable objects at a particular set of one or more prices. The trade prompt also comprises information based on the selected results. For example, if the selected results include a chart or a report, the chart or report (or portions thereof) may be included in the trade prompt. The information of the trade prompt is graphically associated, for example is arranged within a particular document, window or information panel that may be manipulated as a single graphical component.

At block 250, the generated trade prompt is communicated. It may be communicated to a user of the second computing device 130 in FIG. 1. It may be communicated by sending a financial transaction message. A financial transaction message may comprise at least a reference to the trade prompt, or in certain cases data associated with the trade prompt itself. The financial transaction message may enable the use of the second computing device 130 to, at said device, access and view the trade prompt. In one example, a reference may comprise one or more uniform resource identifier (URIs), which may comprise uniform resource locators (URLs) that identify one or more servers where trade prompt data is hosted. In one case, a URL may be a secure URL, for example according to the standards and protocols used by Hypertext Transfer Protocol Secure (HTTPS) communications. The server may comprise the financial information server 150 in certain examples. In this example the trade prompt may comprise an Extensible Markup Language (XML) or a HyperText Markup Language (HTML) standard-compliant document, wherein the XML or HTML document is retrieved from the server and displayed on the second computing device 130. In one example, the trade prompt may be communicated by a messaging or other electronic communications application such as social media and/or e-mail. This may also be a secure or secured communication. In one example, whole or part of an XML or HTML document that comprises the trade prompt may be communicated to the user, and as such received by the user at the second computing device 130. In another example, the trade prompt may be defined using one or more Java source files. These may be compiled into Java bytecode files (e.g. .class or .jar files) that may be communicated to the user of the second computing device. The bytecode files, in certain cases, may be encrypted, e.g. and only decrypted by the addressed user of the second computing device. The trade prompt would thus be executable on the second computing device using a Java Virtual Machine (JVM) installed on the second computing device. In these cases the trade prompt may be executable within a secure environment to prevent interception of commands and/or data.

Following block 250, access to the trade prompt generated at step 240 is provided to a user. In one example the trade prompt may be generated by way of the first computing device 110 and then accessed by a user of the second computing device 130. Access to the trade prompt enables a user, such as a user of the second computing device 130, to instruct a trade of one or more tradable objects based on the trade prompt. For example said user may click on a user interface component using the second computing device 130 to instruct the trade. The trade prompt as accessed by the user may be editable via the user interface of the second computing device before execution of the trade. For example, when preparing the trade prompt on the first computing device 110 a user may specify, either directly through editing the prompt or indirectly by specifying a particular data object, a quantity of a tradable object. This quantity may then be displayed to the user of the second computing device 130 when they access the trade prompt. The user of the second computing device 130 may then edit the quantity before executing the trade representing in the trade prompt.

In certain cases one or more blocks of the above described method may be implemented by one or more server computers. For example, at least one or more of the blocks of FIG. 2 may comprise and/or result from one or more API calls on one or more server computers. These server computers in turn may comprise one or more processors coupled to working memory and arranged to execute program code to provide the described functionality.

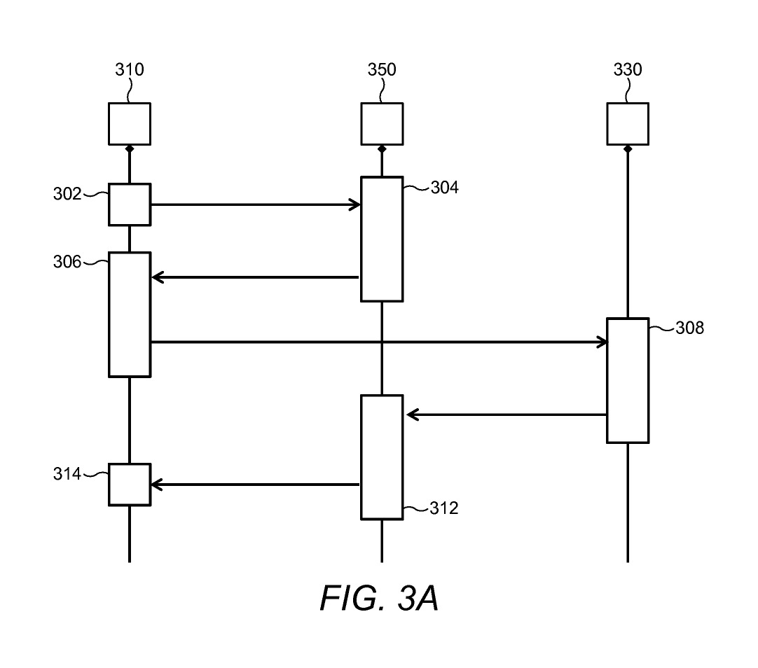

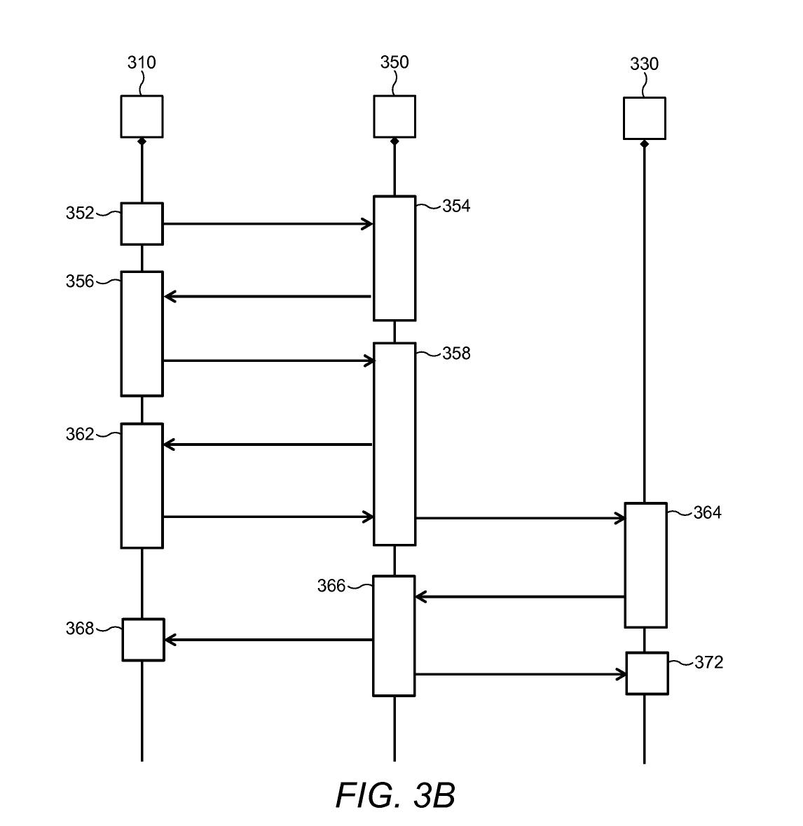

FIG. 3A shows a sequence of events for generating a financial transaction according to a first example. A vertical axis representing process time is shown for each of three entities: a first computing device 310, a second computing device 330 and a server 350. These entities may comprise the first computing device 110, the second computing device 130 and the financial information server 150 of FIG. 1. The sequence begins with process 302 on the first computing device. A process may comprise the execution of computer program code loaded into working memory on one or more central processing units. Process 302 displays a user input component on a display of the first computing device 310. The user input component enables a user of the first computing device 310 to enter, or otherwise select, data to be used in a query. In one example the user input component may comprise a text box; additionally or otherwise input may also be provided by selecting a displayed item (e.g. a word in a document, an option from a dropdown menu, a chart or an item in a trade ticket). In the latter case process 302 maps the selection into a query input. Data for the query is then sent to server 350 where it is received by process 304. Process 304 may represent an implementation of the first interface 152 and/or the query engine 154 as shown in FIG. 1. Process 304 may pre-process said data following receipt if required, e.g. put said data into a canonical form suitable for a query. Process 304 uses the data to perform a query upon one or more sources of data. These sources of data may comprise one or more databases 156 as shown in FIG. 1 and/or may comprise remote repositories of information such as remote servers accessed via a query API. In one example, the query may use one or more commands or statements in a query language, such as a structured query language (SQL). The query may combine results from multiple data sources. Filtering may be applied following execution of the query. The results of the query may be returned as one or more links and/or references to data objects in one or more data sources. Alternatively, or additionally, results of the query may comprise the whole or a portion of the data stored within one or more data sources. In one example, information may be organized using a HTML and/or XML framework. In this case the server 350 may make use of a query engine to return results in the form of one or more URIs, which may comprise URLs. The query engine may comprise and/or interact with a search engine in certain examples.

After process 304 has executed one or more queries and collected a set of one or more results these are returned to process 306 operating on the first computing device 310. Process 306 then processes the results received from the server 350 so as to display them to the user of the first computing device 310, for example upon a suitable user interface. If the results comprise one or more URIs or URLs then a live preview of one or more referenced data object may be presented to said user. In one case, at least portions of an HTML or XML document may be returned from process 304 enabling display of each data object on the first computing device 310. In another case, each URL may enable the first computing device 310 to retrieve the appropriate portions of an HTML or XML document from a remote server. In certain cases each data object that forms part of the search results may be interactive, e.g. a user may be able to interact and/or edit the returned data object. For example, the user may be able to change a view of a chart or graph or change a time range for historical market data.

As part of process 306 in FIG. 3A a user of the first computing device 310 is able to select one or more data objects returned from the query. Selection may be performed in a number of different ways depending on the implementation. In one case, the user may select a data object in a list of search results by clicking on it or an accompanying checkbox with a mouse; in the same or another case, a data object may be selected by dragging it to a particular area of a display, e.g. undocking the data object from one location and docking it at another, separate location; and in yet a further complimentary or different case, one or more data objects may be selected by the use of a particular predefined touch gesture. Data objects that have been selected form the basis for a trade prompt. In one case, process 306 generates a new HTML or XML document as a container for the selected data objects; this forms the basis of the trade prompt. Information within said document may be populated by retrieving data associated with each data object. Process 306 may use one or more templates to structure said document. Once a trade prompt has been generated the user of the first computing device 310 may edit, if desired, the pre-loaded data.

Once a user of the first computing device 310 is happy with the form of the trade prompt it may be communicated to a user of the second computing device 330. In a case where the trade prompt comprises an HTML or XML document it may be communicated in whole or part to the second computing device. In another case a reference such as a URL to said document may be generated and sent to the second computing device. In one case, the user of the first computing device 310 selects one or more addresses of appropriate users, one of which being the user of the second computing device 330. In another case, one or more user addresses may be pre-loaded based on previously-displayed information, e.g. a previous state of the first computing device 310 such as an active client account that is displayed on a user interface. The addresses may comprise identifiers for a particular user, account and/or organization within one or more web services, such as e-mail addresses and/or social media identifiers. In these cases the trade prompt may be communicated indirectly, e.g. via one or more intermediate servers that may have state to store at least a reference to the trade prompt. In another example, the address may comprise a network username and/or an identifier for the second computing device 330.

At the second computing device 330, the user of the device receives at least an indication that a trade prompt has been communicated to them. This occurs as part of process 308. In one case, a message may be displayed to the user indicating a financial transaction message has been received. In another case, the user of the second computing device 330 may be required to check a particular application or user interface component that displays receipt of a financial transaction message associated with the trade prompt. If a financial transaction message is received, the user of the second computing device 330 may activate the financial transaction message, for example by activating a URL, to display the trade prompt on the second computing device 330. This may comprise downloading and appropriately rendering an HTML or XML document. Rendering may be performed by process 308 or a third party application. Activation and/or viewing of a trade prompt may happen asynchronously, e.g. at a later time as decided by the user of the second computing device 330.

The user of the second computing device 330 may be able to edit the information displayed in the trade prompt. This may be performed by editing local and/or remote data associated with the trade prompt. If the user of the second computing device 330 wishes to execute the trade representing in the trade prompt, whether edited or unedited, they enter a command via the second computing device 330. This may comprise activating a user interface component. In this example, a message is communicated to server 350 following receipt of this command. In process 312 the server 350 instructs the trade. For example, server 350 may directly or indirectly send an order message to an electronic exchange where tradable objects may be bought or sold to instruct the trade. Alternatively server 350 may make a trade directly with a third-party without the use of an electronic exchange, e.g. set-up an over-the-counter contract. The server 350 may make the trade on behalf of the user of the second computing device or the trade may be made between the user of the second computing device and an entity that controls server 350. The trade is instructed based on the values of the trade prompt at the time of execution, e.g. based on the values resulting from the generation of the trade prompt subject to any edit by the users of each computing device. Following instruction of the trade, e.g. after one or more order messages have been sent, the server 350 sends updated data incorporating the instructed trade to the first computing device 310. At process 314 the user interface of the first computing device 310 is updated to take into account the instructed trade. For example, account information for the user of the second computing device 330 may be updated and/or the trade may be added to a list of active trades for the same user. One or more of the first computing device 310 and the server 350 may monitor the status of the trade such that when an order is fulfilled and/or is deemed not possible within an appropriate timeframe the data shown on the user interface of the first computing device 310 is further updated.

FIG. 3B shows a sequence of events for generating a financial transaction according to a second example. This example is similar to the first example, but in this case the process of generating a trade prompt is performed at server 350. At process 352 a user of a first computing device 310 again sends query input data to server 350. At process 354 the server 350 executes the query based on the input data and returns a set of results to process 356 on the first computing device 310. In the second example, only references relating to the data objects in the search results are sent to the first computing device 310. As part of process 358, the server 350 receives selection information from the first computing device 310 for use in generating a trade prompt. At process 358 the trade prompt is generated at the server 350 based on the selection information. A reference to the generated trade prompt is then sent to the first computing device 310. As part of process 362 the user of the first computing device 310 may edit the trade prompt as hosted on the server 350.

Once a user of the first computing device 310 is happy with the form of a particular trade prompt, a command to communicate the trade prompt to an identified user of a second computing device 330 is sent to the server 350 from the first computing device 310. The server 350, as part of process 358, then arranges for a financial transaction message to be communicated to the user of the second computing device 330. As part of process 364 the user of the second computing device 330 may edit parameters and data values associated with the trade prompt as hosted on the server 350. When the user of the second computing device 330 wants to make a trade based on the information in the trade prompt, a message is sent form the second computing device 330 to the server 350. As part of process 366 the server instructs the trade, response to the message from the second computing device 330. Instruction and/or execution of a trade associated with the trade prompt are then communicated to both the first computing device 310 and the second computing device 330. Users of these devices may then view details of the trade as part of respective process 368 and 372. Viewing details of an instructed and/or executed trade may comprise accessing data managed by server 350.

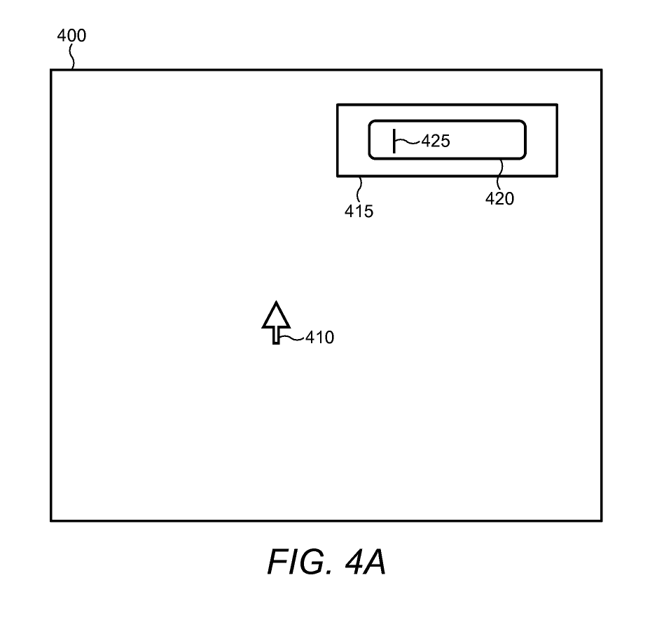

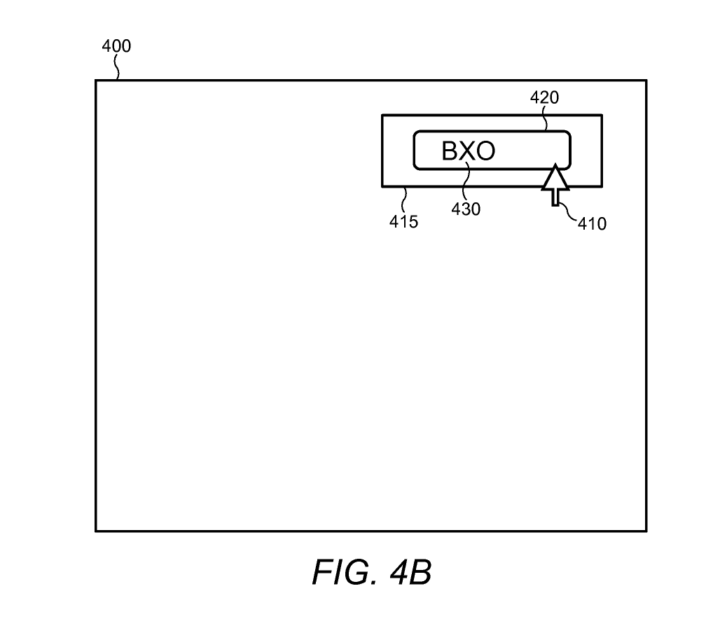

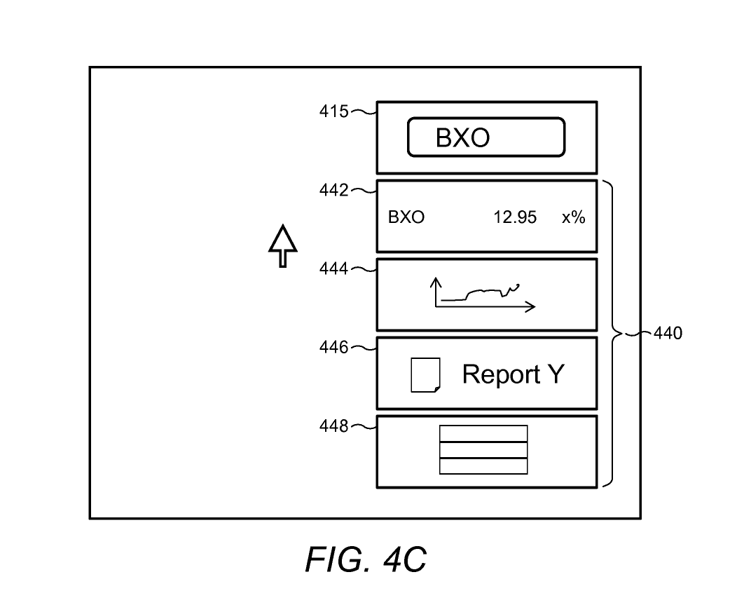

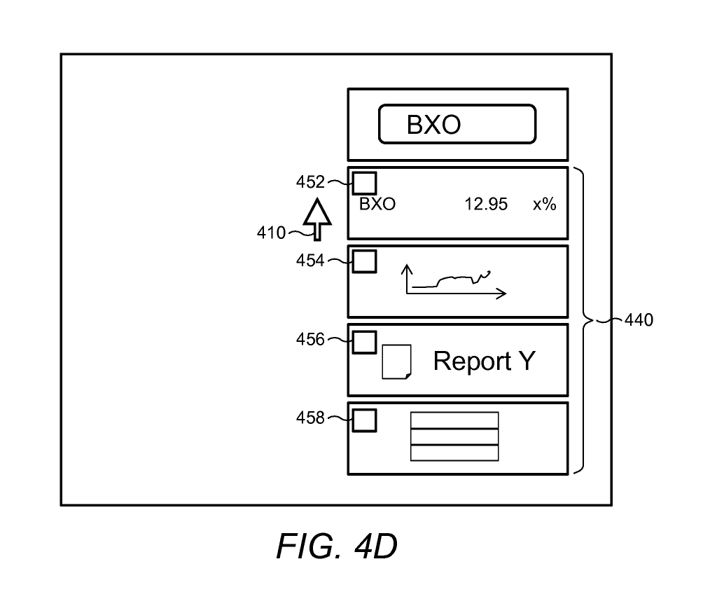

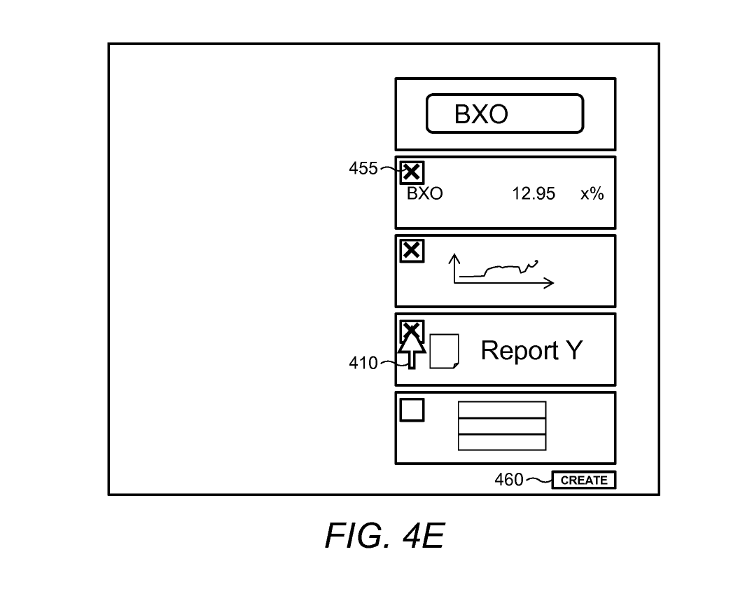

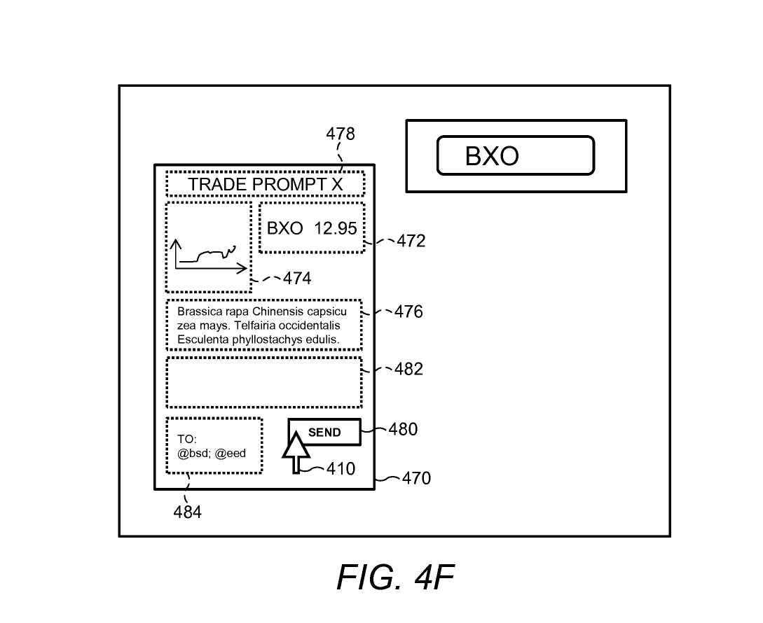

An example of preparing a financial transaction will now be described with reference to a user interface of a first computing device. This example is shown in FIGS. 4A to 4F. This example may represent an implementation of one or more of the methods and sequences shown in FIGS. 2, 3A and 3B and/or may be performed using the system 100 of FIG. 1. Alternatively, the example may form part of a different method and/or system.

FIG. 4A shows an exemplary user interface 400 of a first computing device. The user interface may be implemented at least in part by an operating system loaded into working memory of the first computing device. For example, operating system routines may handle standard user input such as manipulation of a pointing device with pointer 410. Pointer 410 may alternatively represent a touch screen and/or gesture based input. FIG. 4A shows, in a simplified form, a user interface component 415 for entering data for a financial information query. The user interface component 415 may be moveable displayed on screen 400. In FIG. 4A the user interface component 415 comprises a text input box 420. On selection a user may enter text at cursor 425. In this case, user interface component 415 comprises a search box. In certain examples, the user interface component 415 may additionally or alternatively allow command entry, for example comprise a command-line interface and/or a text interface for a command-line interpreter.

FIG. 4B shows how a user may enter a simple text query. The user selects the user interface component 415 using the pointer 410 and in this case enters a text string “BXO”. In this example, the text string represents a code for a fictional tradable object; however, it may among others comprise: natural language input (e.g. “find me ideas relating to gold” or “trades for Dave at DDUK”) and terms and/or phrase (“bond switch Europe”). A search may be executed, amongst others, by a key command (such as enter), by clicking on a “search” user interface component (not shown) and/or automatically as a user enters data. Although this example shows text-based data entry, graphical data entry may also or alternatively be used.

FIG. 4C shows a set of search results 440. These search results are associated with the query input data, in this case the term “BXO”. The search results in this example comprise four information panels 442, 444, 446, 448. In other examples a scroll option and/or a reduced resolution (e.g. thumbnail) view of each search result (i.e. each information panel) may be provided to enable navigation of multiple search results. The search results in the present example are shown aligned and descending vertically from the user interface component 415; however, other arrangements are possible, such as carrousel and/or rotation arrangements, tiles, combinations of one or more horizontal and/or vertical panels etc. . . . . In FIG. 4C the first panel 442 illustrates current information for the tradable object represented by the code “BXO”. This includes current price and one or more statistics. The second panel 444 shows a chart associated with the input data, e.g. associated with a tradable object represented by the code “BXO”; for example, this could be a stock market index that includes the tradable object, an industry performance index for an industry associated with the tradable object or a geographically-limited index, such as gross domestic product, for a country associated with the tradable object. The third panel 446 shows a report associated with the input data, for example an industry, asset or country report. The report may comprise an electronic document such as a word-processing document or a portable document format (PDF) document. The document may set out an economic briefing relating to a particular set of trades or securities. The fourth panel 448 in this example lists social messaging data associated with the input query. For example these may comprise public and/or private messages that contain the input search term or an associated term.

FIG. 4D shows how a user of the first computing device may select one or more information panels containing the returned search results. In FIG. 4D each panel has a user interface component, 452 to 458, in the form of a checkbox. This may be always visible or visible in response to a particular command such as a keyboard shortcut or selection event. A user may then activate zero or more of the information panels 442 to 448 by activating a respective user interface component 452 to 458.

FIG. 4E shows the selection of information panels 442, 444 and 446 using pointer 410. In FIG. 4E a user interface component is shown as being activated by the presence of a cross, and activation is achieved through activation of pointer 410 within the area bounded by each user interface component. FIG. 4E shows a further user interface command 460. The user interface command 460 may be always visible or visible in response to a particular command such as a keyboard shortcut or selection event. On activation of the user interface command 460 a trade prompt is generated based on the selected information panels.

FIG. 4F shows an example of a trade prompt 470 that is generated based on the information panels selected in FIG. 4E. As can be in FIG. 4F, data from information panel 442 is used to populate trade prompt section 472; data from information panel 444 is used to populate trade prompt section 474; and data from information panel 446 is used to populate trade prompt section 476. In trade prompt section 476 data has been extracted from the report shown in the search results; in other examples, a link to the report may be provided. Data from each information panel may be displayed in the trade prompt as presented in the search results and/or may be formatted according to one or more parameters associated with the trade prompt. Data in trade prompt section 472 represents tradable object parameters that specify a particular trade to be placed. In FIG. 4F the trade prompt also has a title 478. This may be generated automatically based on the selected search results. There is also a trade prompt section 482 for a text, audio or video message to accompany the prompt. The recipient(s) of the trade prompt are displayed in trade prompt section 484—these may be selected by a user, for example from an electronic address book, and/or automatically, for example based on a search result and/or previously-viewed account information. Finally, the trade prompt 470 shown in the example of FIG. 4F has a command 480 that may be activated by a user to communicate the trade prompt to the listed addressees.

In certain cases parameters for a trade prompt may be determined automatically. In one case a quantity and/or price for a trade may be automatically generated based on one or more of: a configuration or template for the recipient of the trade prompt; market knowledge; time of day; size of trade; market liquidity; certainty of fill; previous trades; best values etc. . . . .

In certain cases each individual financial transaction message, e.g. associated with a trade prompt for a particular user, may have a unique reference. This may apply to one or more of the message and the trade prompt. This unique reference may be used to track trades that are instructed via the trade prompt and thereby monitor the performance of the user of the first computing device. The unique reference may be associated with a URL sent to one or more users. In another case, a common financial transaction message could be broadcast to a plurality of users, e.g. all users managed by a particular user of a first computing device. In this case, the common financial transaction message may allow access to a trade prompt and a link to a particular user account may be made on view and/or activation of one or more of said message and/or prompt. For example, when a particular user of a second computing device instructs a trade based on a common financial transaction message, an identifier for that user may be associated with the trade instructions and sent to a server for execution.

As shown in the trade prompt section 484 of the example of FIG. 4F, a trade prompt may be sent to one or more recipients. In one variation, these recipients may be selected manually by a user and/or automatically using a recommendation engine. A recommendation engine may be passive or active. A passive recommendation engine may select a given set of users based on one or more predetermined rules, for example a database query may be used to retrieve all user accounts associated with a logged-in user of a first computing device. Or in another implementation, the recommendation engine may return a list of contacts associated with a particular user. Any retrieved accounts in this example may then be further refined based on manual selection by said user and/or one or more filters applied to the retrieved user accounts. An active recommendation engine may take as input one or more variables, for example one or more variables derived from the content of a generated trade prompt. It may then apply a probabilistic and/or statistical analysis of these variables, for example based on historic data, to actively select one or more user accounts. This analysis may be described as “intelligent selection”. For example, if the trade prompt comprised a trade ticket for a Euro-bond and a particular user had a history of trading this financial instrument that user may be returned as a potential recipient. Or in another example, k-Nearest Neighbor clustering on feature vectors derived from the trade prompt information may be used to select sets of one or more users.

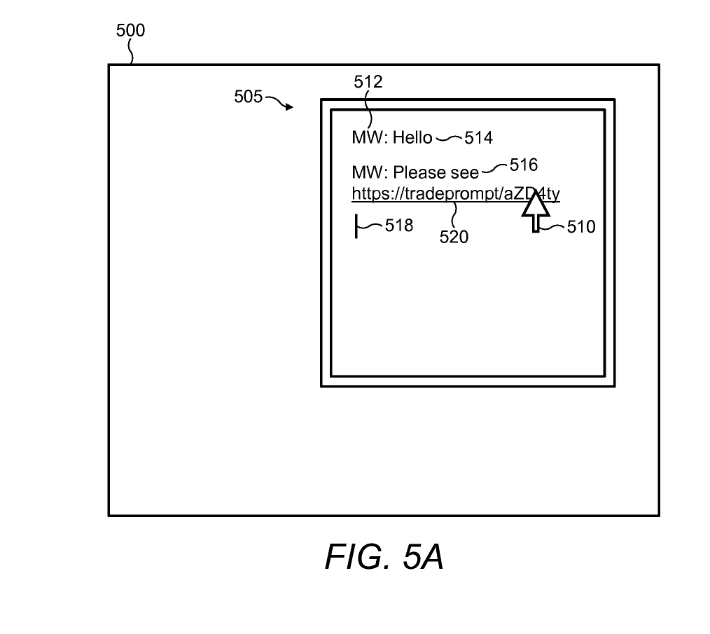

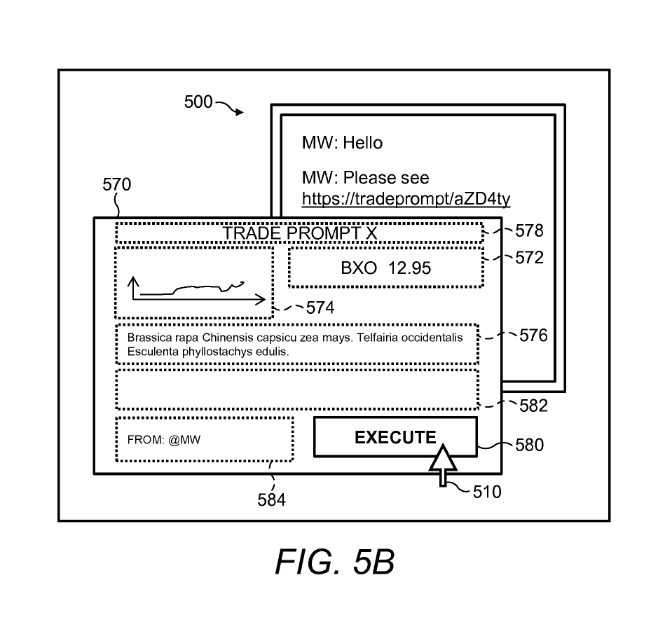

FIG. 5A shows a user interface 500 of a second computing device according to an example. The user interface may be implemented at least in part by an operating system loaded into working memory of the second computing device. For example, operating system routines may handle standard user input such as manipulation of a pointing device with pointer 510. Pointer 510 may alternatively represent a touch screen and/or gesture based input. FIG. 5A shows a user interface component for an electronic messaging application 505. The electronic messaging application 505 may also be loaded into working memory. The electronic messaging application 505 may comprise a standalone application or form part of another application, such as a web browser. The electronic messaging application 505 allows messages to be exchanged between the user of the first computing device and a user of the second computing device. FIG. 5A shows a first message 514 from the user of the first computing device, denoted by identifier “MW” 512. Following the first message 514, there is a second message 516 from user “MW”. The second message 516 comprises a URL 520 that provides a reference to a trade prompt. The user of the second computing device has an option to reply to user “MW” by typing a message at cursor 518 and/or activating the trade prompt by clicking on the URL using pointer 510. In this example the URL is a secure URL.

FIG. 5B shows the result of clicking upon the URL 520 in FIG. 5A: a trade prompt 570 is displayed upon user interface 500. This may be implemented by securely retrieving and displaying an HTML or XML document using the URL. One or more credentials associated with the second computing device and/or the user of said device may also be used to authenticate said user, for example to the server identified by the URL. In certain implementations an application may be downloaded from the URL, wherein the details of the trade prompt are embedded within the application and/or are retrieved based on supplied parameters. For example, such an application may comprise Java bytecode. In certain implementations a client application may be installed on the second computing device that monitors for activation of URL 520 and subsequently renders the trade prompt in a specific format.

In FIG. 5B, the trade prompt 570 displayed to the user of the second computing device resembles the trade prompt 470 as generated by the user of the first computing device. For example, trade prompt 570 comprises: a trade prompt section 572 displaying data associated with a particular trade, e.g. data for one or more tradable objects; chart 574; report data 576; title 578; and message 582. An identifier and/or address of the user of the first computing device 584 are also displayed. A user interface command 580 enables the user of the second computing device to instruct the execution of the trade depicted in the trade prompt 570. The user of the second computing device may edit details of the depicted trade, for example by editing data in trade prompt section 572 before selecting user interface command 580. Editing data for a trade prompt may be performed using one or more user interface input components. These components may enable fields such as trade volume, price, time etc. to be changed, added and/or removed by the user of the second computing device. The user interface components that are displayed may be specific to one or more tradable objects featured in the trade prompt, e.g. to the type or kind of said objects.

In certain cases proposed trade parameters may require a request for quotation (RFQ). For example, trades over a particular amount may not be able to be executed immediately and may require a process to authorize the trade. Limits for a particular user may be determined automatically based on a user template. An appropriate user interface command 580 may be shown to the user of the second computing device depending on the parameters of a viewed trade prompt. For example, if the user edited a trade amount such that a trade limit was breached, an “execute” user interface command may be replaced with a “Submit RFQ” user interface command and a submitted trade prompt may be appropriately routed to the correct server process. In a trade prompt is communicated to a plurality of users, each limit may be set automatically by reference to a user-specific template, or database record, for each user. In certain cases, the limits may be displayed to the user as part of the trade prompt.

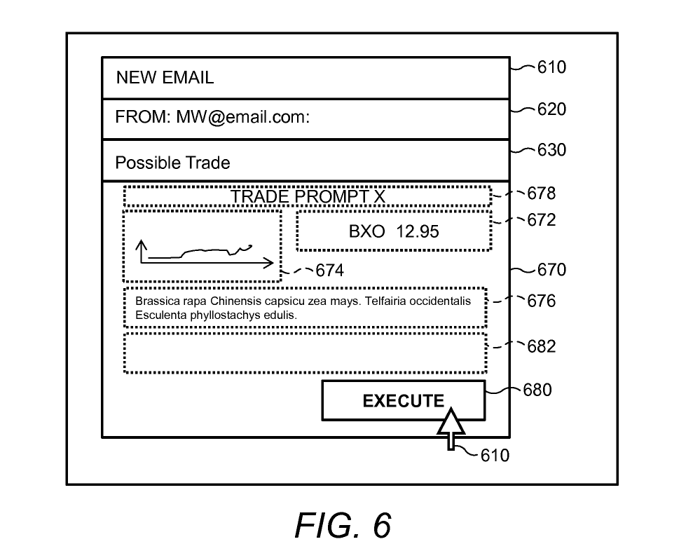

FIG. 6 shows an alternative method of delivering a trade prompt to a user of a second computing device. In the example of FIG. 6 the user of the second computing device receives an email, by, for example, accessing an electronic mail exchange, accessing an online electronic mail provider or otherwise downloading data representing the email. The email may be loaded in the user's default email management application 610 on the second computing device. The email of FIG. 6 is received from the user of the first computing device 620. The subject line of the email 630 indicates it relates to a trade that may be of interest to the user of the second computing device. Active content representing the trade prompt is shown in the body of the email 670. As with the previous trade prompt representations the email body 670 comprises: a trade prompt section 672 displaying data associated with a particular trade; chart 674; report data 676; title 678; and message 682. A user interface command 680 enables the user of the second computing device to instruct the execution of the trade depicted in the trade prompt. In certain cases an email may comprise an attachment that is renderable and/or executable by either the email management application 610 or a client application on the second computing device.

The examples of FIGS. 5A, 5B and 6 may be used in cases where there is no specialized application for rendering a trade prompt installed on the second computing device. In these cases the trade prompt may be encapsulated, wherein all data required to view and/or instruct the trade prompt are accessible to the user of the second computing device. For example, this data may comprise: one or more credentials to authorize the user of the second computing device to one or more servers (including third party servers) for instructing the trade in the trade prompt; additional authentication routines for the user of the second computing device (e.g. requiring a password and/or biometric data etc.); and references and/or routines to establish secure communications with data sources and/or trading servers.

In certain examples, a trade prompt may be received in a dedicated trade prompt inbox for a particular user. In this case a summary of the trade prompt may be displayed in one section of the user interface. At least a summary for a newly received trade prompt may be displayed together with at least summaries for previously-received trade prompts. In this manner a user of a second computing device may be able to view the status of previous trades via the historical information set out in the previously-received trade prompts. A user of the second computing device may also, or alternatively, be able to track the status of instructed trades. This may be performed across multiple platforms including mobile devices. Information such as forward rates and fill status may be returned to a user in association with a pending order.

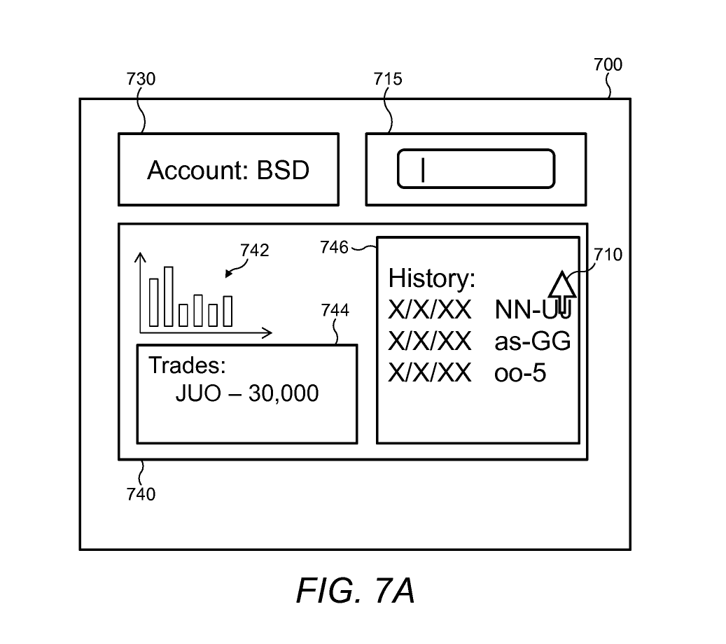

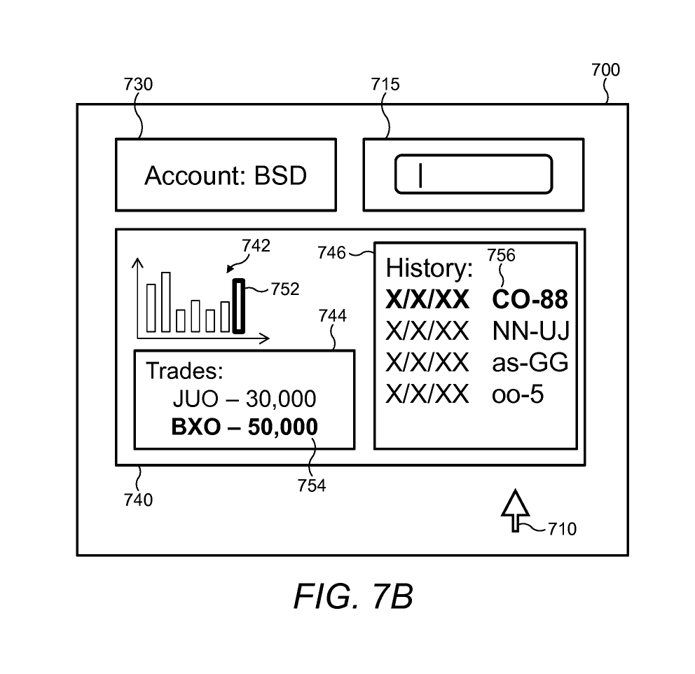

FIGS. 7A and 7B show a user interface 700 that displays user account data according to an example. The user account data may be associated with one or more of a user of the second computing device and a legal entity associated with said user, for example a company that employers said user. The user interface 700 may comprise a user interface component 715, which may implement the same functionality as user interface component 415 in FIGS. 4A to 4F. FIG. 7A shows statistics for an account linked to company “BSD”, as displayed in account identification component 730. The statistics are displayed in information panel 740. In the example of FIG. 7A a bar chart of trade volume (e.g. in total price value) with time for the particular account is shown at 742, a list of past trades and quantities is provided in section 744 and a third section provides a date-organized list of communications between a user of the first computing device as described in the previous examples and members of the company “BSD”, which in this example includes the user of the second computing device.

FIG. 7B shows an example of how data associated with a user account may be updated when a user of a second computing device instructs a trade based on a trade prompt. For example, FIG. 7B may represent the result of one or more of processes 314 and 368 in FIGS. 3A and 3B. As shown in FIG. 7B, a new trade entry 754 is added to section 744. This entry reflects the details of the trade as set out in a trade prompt that is approved by the user of the second computing device. The user of the first computing device may be able to edit pending, yet-to-be-filled orders via section 744, for example at request of the user of the second computing device. The volume of the recently instructed and/or executed trade is also added to chart 742, for example as bar 752. The history of communications shown in section 746 is also updated to list the date of the communication of the trade prompt, together with details of any messages, edits and/or modifications as required. The statistics may also be updated to show trade channel data, for example that a trade has been instigated using electronic communication means (e.g. as opposed to telephone or in person). In general the statistics may relate to any desired customer relationship management data and may include turnover and credit amounts.

In certain examples the search or query results that are returned to a user may be filtered based on a user configuration. For example, user templates may be generated. These may filter results such that only certain results that are relevant for a particular user are returned. This may apply to both the user of the first computing device and the user of the second computing device. For example, when a particular user account is displayed as in FIGS. 7A and 7B, a search template for the currently-viewed user may be applied to searches performed via user interface component 715. If account BSD is only able to trade in a particular geographical area, or trade particular objects, these limitations may be applied to any search performed when viewing that account. A user account may also have various trading limits; these may be applied to returned search results. For example, if account BSD has a trading limit of X US dollars per week then trades and/or trade ideas that go over that limit may not be displayed. This may be applied equally to users operating the user interface shown in FIGS. 4A to 4F, such that appropriate search content is returned.

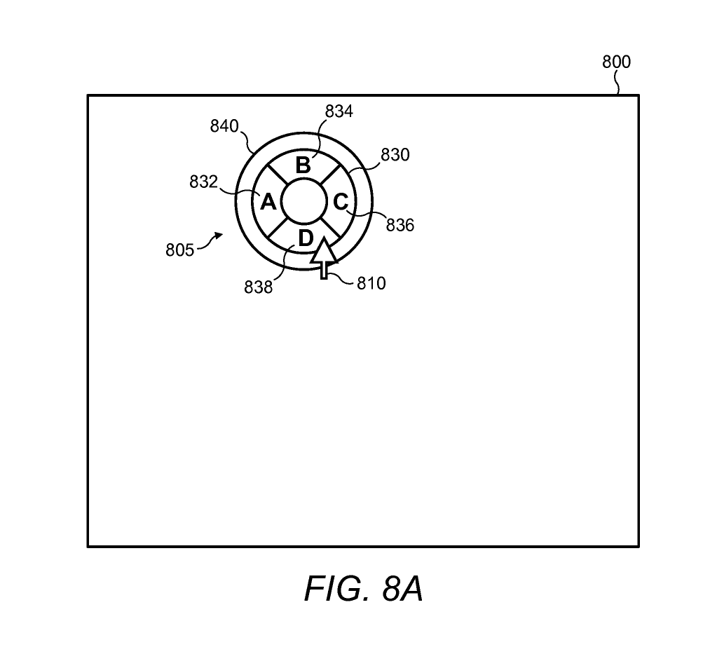

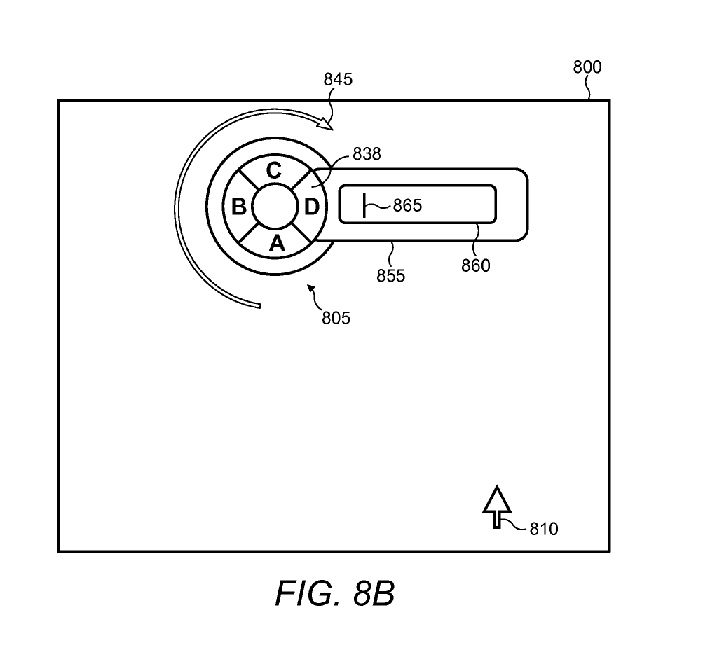

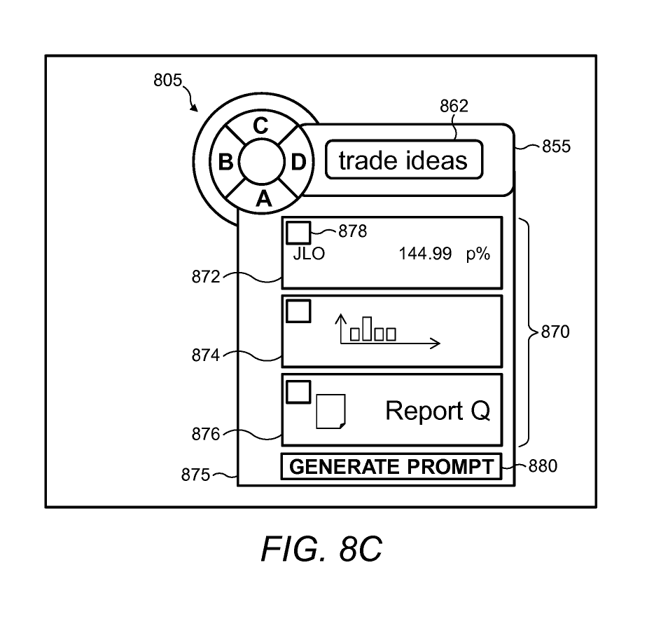

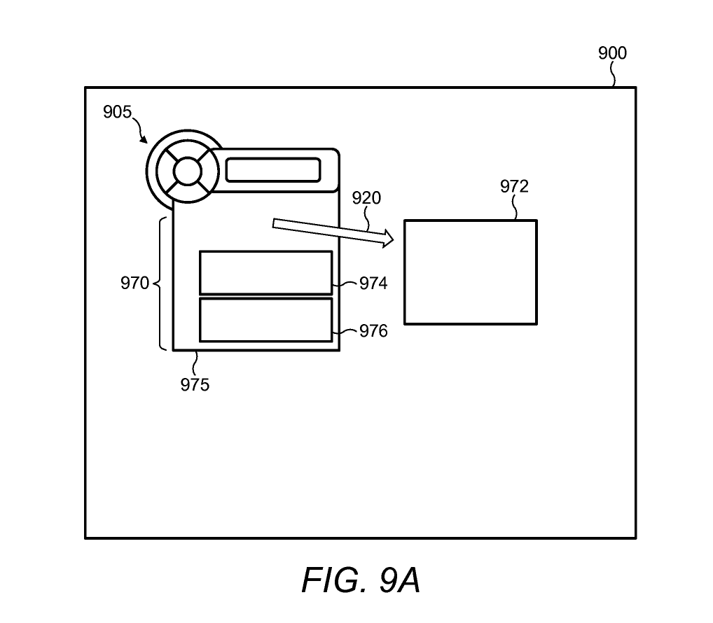

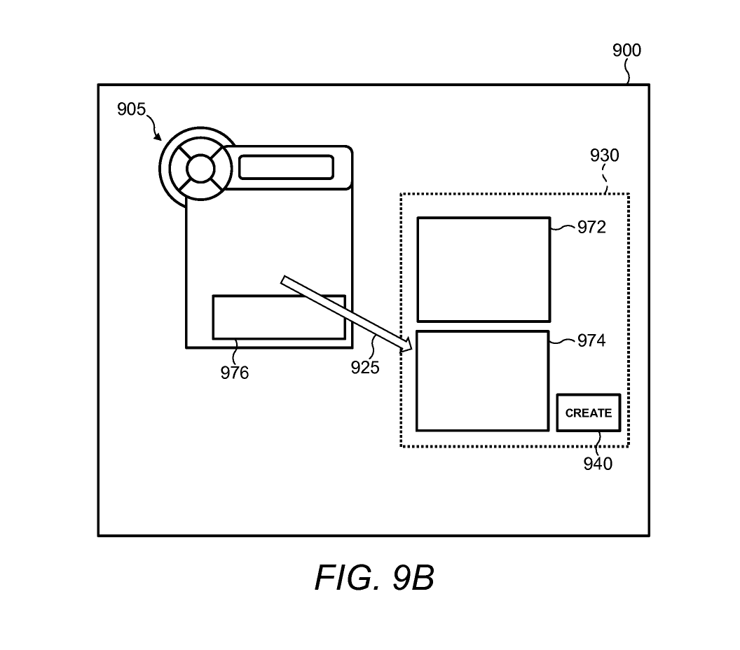

FIGS. 8A to 8C and 9A to 9B show an example of a user interface component for use for searching for information. This user interface component may be used with or without the methods and systems described above; for example, in certain cases it may comprise a variation of user interface component 415 in FIGS. 4A to 4F or user interface component 715 in FIGS. 7A and 7B. The user interface component of the present example may be used to search for information without further use in a method for preparing a financial transaction.

FIG. 8A shows a user interface 800, which may comprise a computer desktop as displayed on a display. User interface component 805 is arranged within this user interface 800. In one example, user interface component 805 may be layered “on-top” of other windows and graphical user interface components displayed on the user interface. The user interface component 805 of FIG. 8A is circular and comprises a central region surrounded by one or more annular portions 830 together with a background annulus 840. In FIG. 8A there are four annular portions: portion A 832; portion B 834; portion C 836; and portion D 838. In other examples there may be greater or fewer portions. In the present example each annular portion 830 comprises a command button that may be selected using a pointer 810 (or a touch-screen/gesture based equivalent). The central region may also comprise a command button. Each command button may link to a different function and may change color to indicate different states and/or alerts. For examples, available functions may comprise one or more of “search”, “settings” and “alerts”. The “alerts” command button may indicate alerts, e.g. by changing color, such as user trades or activation of trade prompts that have been sent to a different user. The central region may comprise a command button that displays a default user interface screen or panel (a so-called “home” screen). Background annulus 840 may comprise an opaque or semi-opaque region. This may help distinguish the user interface component 805 from background user interface layers. The user interface component 805 is arranged to provide required functionality while using a minimum amount of screen area.

FIG. 8B shows how the user interface component 805 may be rotatable to indicate different selected functions. For example, FIG. 8B may represent the result of a user selecting annular portion D 838, e.g. by clicking with a pointer 810 as illustrated in FIG. 8A. In this example, annular portion D 838 may represent a command button for selecting a “search” function. When annular portion D 838 is selected the user interface component 805 rotates such that annular portion D 838 is aligned with a horizontal axis of the user interface component 805. In FIG. 8B the annular portion D 838 rotates clockwise as indicated by arrow 845 and a horizontal component 855 extends from the annular portions 830 in front of background annulus 840. The horizontal component 855 in this example comprises a text input box 860 where a user can enter search terms and/or commands at cursor 865. The projection of horizontal component 855 on the right-hand-side of the illustrated user interface component 805 is arranged as text will be entered from left-to-right at cursor 865.

FIG. 8C shows a result of an example search function that may be performed by entering terms in the text input box. In this particular example the user has entered the search term “trade ideas” 862. A query has been performed using this term, for example as described above, and the search results are presented in information panels 870. Information panels 870 are displayed within a drop-down portion 875 of user interface component 805 that extends below and behind horizontal component 855. As with previous examples, information panels 870 may comprise interactive data objects, for example each panel may be used as an independent and separate application. A user may select certain panels using check boxes 872, 874 and 876 to generate a trade prompt following activation of command button 880.

FIGS. 9A and 9B show an alternate method of generating a trade prompt. This method may be used with any of the above described examples. FIG. 9A shows a user interface 900 with a user interface component 905, similar to that shown in FIG. 8C. Similarly to FIG. 8C, a number of information panels 970 are provided, for example as search results, in drop-down portion 975. In the present example, a user is able to drag individual information panels 972, 974, 976 away from the drop-down portion 975 such that they detach or “un-dock” from said portion. For example, in FIG. 9A a user has dragged information panel 972 in direction 920 away from the drop-down portion 975. Once exterior to the drop-down portion 975 an information panel may be used as an independent application within the user interface 900, e.g. may represent a window displaying the application. For example, if information panel 972 represents live trade information for one or more tradable objects, a user may be able to make a trade using said information panel and/or look-up historical trade information by interacting with graphical user interface components within the panel.

FIG. 9B shows how a user may generate a trade prompt by dragging one or more information panels from the drop-down portion, e.g. the drop-down portion 975 as shown in FIG. 9A. In FIG. 9B a user drags information panel 974 out of the drop-down portion as illustrated by arrow 925. In this case when information panel 974 is placed near to information panel 972 a frame 930 is generated illustrating the contents of a trade prompt. A “create” or “generate” command button 940 may also be displayed to enable creation and/or communication of the trade prompt, e.g. as described previously. The user may rearrange, reformat and/or resize the dragged information panels or data displayed therein within frame 930, which may also be editable in a similar manner.

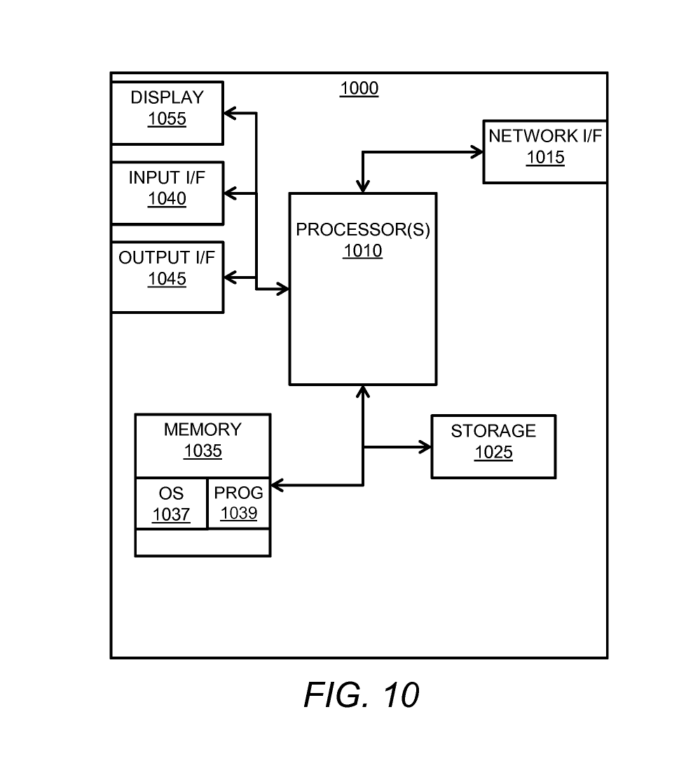

FIG. 10 shows an example of a computing device 1000 that may implement one or more of the first computing devices, second computer devices and servers described herein. One or more processors 1010, such as central processing units, are electronically coupled to one or more of network interface 1015, storage 1025, memory 1035, input interface 1040, output interface 1045 and display interface 1055. These components are for example only, in certain implementations some may be omitted and others that are not shown may be added. Network interface 1015 may be a wired and/or wireless interface for communicating over one or more computer networks. Storage 1025 may comprise a hard disk and/or solid state storage. Memory 1035 may comprise working memory for storing computing program code relating to an operating system 1037 and one or more application programs 1039; said code being processed by the one or more processors 1010. Input interface 1040 may receive signals from input devices such as one or more of a mouse, keyboard, touchscreen, camera (still and/or video), trackpad etc. . . . . Output interface 1045 may output signals to one or more peripherals. Display interface 1055 may be coupled to a display for showing the user interfaces described herein. Dedicated video memory and/or processors may be provided in certain implementations.

Certain methods, apparatus and systems as described herein provide an electronic commerce platform that facilitates interaction pre-, during and post-trade. Trades may relate to any tradable object, for example, interest rate swaps, securities, derivatives, futures, foreign exchange etc. . . . . A trade prompt may be generated that enables a consistent experience for both internal and external users, e.g. users within a financial organization and their clients or customers. Certain examples enable a secure chain of trust to be set up between a user and a trading server such that a trade based on a trade prompt can be instructed and executed.

In certain examples described herein a method of preparing a financial transaction comprises: receiving, via a user interface of a first computing device, input data for a financial information query; displaying, on the user interface of the first computing device, one or more information panels resulting from the execution of the financial information query, said information panels comprising financial information relating to at least one tradable object associated with the input data; selecting, via the user interface of the first computing device, one or more information panels to generate a trade prompt associated with the at least one tradable object; and sending a financial transaction message corresponding to the trade prompt to a user of a second computing device, said message providing a means by which the user of the second computing device can instruct, from the second computing device, a trade of one or more tradable objects according to the trade prompt. The trade may relate to a tradable object traded on an electronic exchange and/or an off-the-counter or off-exchange trade between two or more parties.

In certain cases, a method includes selecting, via the user interface of the first computing device, a user account; and using the user account to determine an identifier for the user of the second computing device, wherein said identifier is used to send the financial transaction message to the user. For example, the identifier may be one or more of: a social messaging identifier, an email address, an internet protocol address, and a telephone number. This method may also comprise displaying data associated with the user of the second computing device on the user interface of the first computing device, wherein the data corresponds to one or more of: user details; previous trades associated with the user; and previous communications with the user. In response to user of the second computing device instructing execution of said trade, the data displayed on the user interface of the first computing device may be updated to take account of said trade.

In certain cases, the content of a trade prompt may be analyzed using a recommendation engine; and one or more additional user identifiers may be provided based on an output of the recommendation engine. For example there may be a step of analyzing at least the content of the trade prompt using a recommendation engine and providing one or more user identifiers based on an output of the recommendation engine, wherein said one or more user identifiers are used to send one or more financial transaction messages to one or more users of one or more respective computing devices. For example, a recommendation engine may be arranged in a similar manner to the recommendation engine described above.

In certain cases, a method further includes executing the financial information query based on the input data. A method may also include, in response to selecting one or more information panels, displaying the trade prompt on the user interface of first computing device, wherein the trade prompt is editable via the user interface of first computing device before the financial transaction message is sent to the user of the second computing device. The trade prompt may be displayed on a user interface of the second computing device in response to receipt the financial transaction message at the second computing device. A trade prompt may be editable via the user interface of the second computing device before instructing execution of the trade and/or the trade prompt may be displayed together with at least references to previous trade prompts received by the user of the second computing device.

Financial information relating to at least one tradable object associated with the input data may comprise at least one or more of: a trade ticket for at least one tradable object; one or more charts for variables associated with one or more of the input data and the trade ticket; one or more documents comprising analysis associated with one or more of the input data and the trade ticket; one or more previous trades associated with one or more of the input data and the trade ticket; one or more additional trade tickets associated with one or more of the input data and the trade ticket; one or more web pages associated with one or more of the input data and the trade ticket; one or more recorded communications associated with one or more of the input data and the trade ticket; and one or more graphics associated with one or more of the input data and the trade ticket.

In certain examples, sending a financial transaction message comprises sending a plurality of financial transaction messages to a respective plurality of users, wherein each financial transaction message provides access to at least a version of the trade prompt such that an instructed trade may be associated with a particular user account. The user interface of the first device may also comprise one or more separable user interface components.

In an example, a financial transaction message comprises a secure uniform resource locator. In one implementation, the first computing device is communicatively coupled to a trading server via a secure first network and the first computing device is communicatively coupled to the second computing device via an unsecure second network, wherein the financial transaction message enables a secure connection from the second computing device to the first network to be established over the second network.

A method may comprise receiving, from the first computing device at a user interface of the second computing device, the financial transaction message, activating the financial transaction message to display the trade prompt on the user interface of the second computing device and selecting a user interface component on the trade prompt to instruct execution of the trade.

In certain described examples, a system for preparing a financial transaction comprises a first computing device comprising a first user interface, a second computing device communicatively coupled to the first computing device and comprising a second user interface, and a financial information server at least communicatively coupled to the first computing device. In this case the first user interface comprises a first interface component for receiving input data for a financial information query and the financial information server comprises a first interface to receive said input data from the first computing device and a query engine to execute the financial information query based on the input data. The query engine may comprise any computer-implemented process for performing a financial information query; for example, it may comprise an API interface, a SQL processor and/or a component arranged to execute a code command. The first user interface also has a second interface component for displaying data output by the query engine of the financial information server, the second interface component comprising one or more sub-components to enable a user of the first computing device to select one or more items of said data output by the query engine to generate a trade prompt, wherein the second computing device is arranged to receive a financial transaction message from the first computing device and, based on the financial transaction message, to display the trade prompt on the second user interface, the second user interface comprising an interface component to instruct a trade associated with the trade prompt. The financial information server may be arranged to receive a command to instruct a trade associated with the trade prompt from the second computing device and to instruct execution of the trade.

In certain described examples a method of preparing a financial transaction comprises: receiving input data for a financial information query; providing data resulting from the execution of the financial information query for one or more information panels, said data comprising financial information relating to at least one tradable object associated with the input data; receiving a selection of one or more of said information panels; and generating a trade prompt associated with the at least one tradable object based on the selection, the trade prompt being communicable to a user of a second computing device and providing a means by which the user of the second computing device can instruct, from the second computing device, a trade of one or more tradable objects.

The above example method may be computer-implemented, for example on one or more server computers and/or processors. The above example method may implement one or more API calls.

Although at least some aspects of the examples described herein with reference to the drawings comprise computer processes performed in processing systems or processors, the disclosure also extends to computer programs, particularly computer programs on or in a carrier, adapted for putting the disclosure into practice. The program may be in the form of non-transitory source code, object code, a code intermediate source and object code such as in partially compiled form, or in any other non-transitory form suitable for use in the implementation of processes according to the disclosure. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc. In use, the computer program may be loaded from the carrier as code and loaded into memory for processing by one or more processors in a computing system. References to “data” and/or “signals” may correspond to analogue or digital representations of information, for each in the form of binary values stored in suitable memory arrays and/or storage devices and accessible by the components described herein.

The above examples are to be understood as illustrative examples. Any element may be extracted in isolation from one described example and used with another example. Further examples are envisaged. For example, information panels may be implemented using any computer technology from HTML and XML documents to independent applications written in one or more programming languages. The examples show various information panels to help explain the described methods and systems, the information panels that are supplied for any one implementation will depend on the configuration of that implementation and any search terms entered. The data shown in FIG. 7A is provided to demonstrate the general functionality of the methods and systems, other data is envisaged. The computing devices may be any type of computing device, e.g. whether fixed or mobile. The first and second computing devices also need not be limited to particular devices, the methods described herein may be distributed across multiple devices wherein state is saved remotely and/or communicated between devices. Data sent between devices may be secured and encrypted.

Although the specification may refer to “an”, “one”, or “some” example(s) in several locations, this does not necessarily mean that each such reference is to the same example(s), or that the feature only applies to a single example. Single features of different embodiments may also be combined to provide other examples. Furthermore, words “comprising” and “including” should be understood as not limiting the described examples to consist of only those features that have been mentioned and such examples may contain also features/structures that have not been specifically mentioned. For example, it is to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the disclosure, which is defined in the accompanying claims.

1. A method of preparing a financial transaction comprising:
receiving, via a user interface of a first computing device, input data for a financial information query;
displaying, on the user interface of the first computing device, one or more information panels resulting from the execution of the financial information query, said information panels comprising financial information relating to at least one tradable object associated with the input data;
selecting, via the user interface of the first computing device, one or more information panels to generate a trade prompt associated with the at least one tradable object; and
sending a financial transaction message corresponding to the trade prompt to a user of a second computing device, said message providing a means by which the user of the second computing device can instruct, from the second computing device, a trade of one or more tradable objects according to the trade prompt.

2. A method according to claim 1, comprising:
selecting, via the user interface of the first computing device, a user account; and
using the user account to determine an identifier for the user of the second computing device,
wherein said identifier is used to send the financial transaction message to the user.

3. A method according to claim 2, wherein the identifier for the user is one or more of: a social messaging identifier, an email address, an internet protocol address, and a telephone number.

4. A method according to claim 2, comprising:
displaying data associated with the user of the second computing device on the user interface of the first computing device,
wherein the data corresponds to one or more of: user details; previous trades associated with the user; and previous communications with the user.

5. A method according to claim 4, comprising, in response to user of the second computing device instructing execution of said trade:
updating the data displayed on the user interface of the first computing device to take account of said trade.

6. A method according to claim 2, comprising:
analyzing the content of the trade prompt using a recommendation engine; and
providing one or more additional user identifiers based on an output of the recommendation engine.

7. A method according to claim 1, comprising:
executing the financial information query based on the input data.

8. A method according to claim 1, comprising:
in response to selecting one or more information panels, displaying the trade prompt on the user interface of first computing device,
wherein the trade prompt is editable via the user interface of first computing device before the financial transaction message is sent to the user of the second computing device.

9. A method according to claim 8, comprising:
in response to receipt the financial transaction message at the second computing device, displaying the trade prompt on a user interface of the second computing device.

10. A method according to claim 9, wherein the trade prompt is editable via the user interface of the second computing device before instructing execution of the trade.

11. A method according to claim 9, wherein the trade prompt is displayed together with at least references to previous trade prompts received by the user of the second computing device.

12. A method according to claim 1, wherein the financial information relating to at least one tradable object associated with the input data comprises at least one or more of:
a trade ticket for at least one tradable object;
one or more charts for variables associated with one or more of the input data and the trade ticket;
one or more documents comprising analysis associated with one or more of the input data and the trade ticket;
one or more previous trades associated with one or more of the input data and the trade ticket;
one or more additional trade tickets associated with one or more of the input data and the trade ticket;
one or more web pages associated with one or more of the input data and the trade ticket;
one or more recorded communications associated with one or more of the input data and the trade ticket; and
one or more graphics associated with one or more of the input data and the trade ticket.

13. A method according to claim 1, comprising:
analyzing at least the content of the trade prompt using a recommendation engine; and
providing one or more user identifiers based on an output of the recommendation engine.
wherein said one or more user identifiers are used to send one or more financial transaction messages to one or more users of one or more respective computing devices.

14. A method according to claim 1, wherein sending a financial transaction message comprises sending a plurality of financial transaction messages to a respective plurality of users,
wherein each financial transaction message provides access to at least a version of the trade prompt such that an instructed trade may be associated with a particular user account.

15. A method according to claim 1, wherein the user interface of the first device comprises one or more separable user interface components.

16. A method according to claim 1, wherein a financial transaction message comprises a secure uniform resource locator.

17. A method according to claim 16, wherein the first computing device is communicatively coupled to a trading server via a secure first network and the first computing device is communicatively coupled to the second computing device via an unsecure second network, and
wherein the financial transaction message enables a secure connection from the second computing device to the first network to be established over the second network.

18. A method according to claim 1, comprising:
receiving, from the first computing device at a user interface of the second computing device, the financial transaction message;
activating the financial transaction message to display the trade prompt on the user interface of the second computing device; and
selecting a user interface component on the trade prompt to instruct execution of the trade.

19. A system for preparing a financial transaction comprising:
a first computing device comprising a first user interface;
a second computing device communicatively coupled to the first computing device and comprising a second user interface;
a financial information server at least communicatively coupled to the first computing device,
wherein the first user interface comprises a first interface component for receiving input data for a financial information query,
wherein the financial information server comprises a first interface to receive said input data from the first computing device and a query engine to execute the financial information query based on the input data,
wherein the first user interface comprises a second interface component for displaying data output by the query engine of the financial information server, the second interface component comprising one or more sub-components to enable a user of the first computing device to select one or more items of said data output by the query engine to generate a trade prompt,
wherein the second computing device is arranged to receive a financial transaction message from the first computing device and, based on the financial transaction message, to display the trade prompt on the second user interface, the second user interface comprising an interface component to instruct a trade associated with the trade prompt.

20. A method of preparing a financial transaction comprising:
receiving input data for a financial information query;
providing data resulting from the execution of the financial information query for one or more information panels, said data comprising financial information relating to at least one tradable object associated with the input data;
receiving a selection of one or more of said information panels; and
generating a trade prompt associated with the at least one tradable object based on the selection, the trade prompt being communicable to a user of a second computing device and providing a means by which the user of the second computing device can instruct, from the second computing device, a trade of one or more tradable objects.
